(19) United States
(12) Patent Application Publication
(10) Pub. No.: US 2006/0103122 A1
(43) Pub. Date: May 18, 2006

(54) Crushed expanded sheet metal filter for an inflator

(75) Inventor: Eric McFarland, Gilbert, AZ (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Vehicle Safety Systems Inc.

(21) Appl. No.: 10/987,970

(22) Filed: Nov. 12, 2004

(51) Int. Cl. B60R 21/26

(52) U.S. Cl. 280/736; 55/525

(57) ABSTRACT

An apparatus (10) for providing inflation fluid for inflating an inflatable vehicle occupant protection device (16) includes an inflation fluid source (12) actuatable to provide inflation fluid. The apparatus (10) also includes a filter (80) for filtering the inflation fluid provided by the inflation fluid source (12). The filter (80) is formed from at least one expanded metal sheet (82) that is crushed such that a wall thickness of the filter is at least twice a wall thickness of the expanded metal sheet prior to being crushed.

### TECHNICAL FIELD

The present invention relates to an inflator for providing inflation fluid for inflating an inflatable vehicle occupant protection device, and particularly relates to a filter through which inflation fluid is directed.

### BACKGROUND OF THE INVENTION

Inflators that provide inflation fluid to inflate an inflatable vehicle occupant protection device are known. The known inflators may include filters through which the inflation fluid is directed to remove particulates from the inflation fluid or to help cool the inflation fluid.

### SUMMARY OF THE INVENTION

The present invention relates to an apparatus for providing inflation fluid for inflating an inflatable vehicle occupant protection device. The apparatus includes an inflation fluid source actuatable to provide inflation fluid. The apparatus also includes a filter for filtering the inflation fluid provided by the inflation fluid source. The filter is formed from at least one expanded metal sheet that is crushed such that a wall thickness of the filter is at least twice a wall thickness of the expanded metal sheet prior to being crushed.

The present invention also relates to an apparatus for providing inflation fluid for inflating an inflatable vehicle occupant protection device. The apparatus includes an inflation fluid source actuatable to provide inflation fluid and at least one expanded metal sheet crushed to define a filter. The filter has a wall thickness. The expanded metal sheet when crushed defines a plurality of tortuous paths that extend through the wall thickness of the filter. Inflation fluid flows through the tortuous paths. Materials in the inflation fluid are collected in the crushed expanded metal when the inflation fluid flows along the tortuous paths. The wall thickness of the filter is at least twice a thickness of the expanded metal sheet.

The present invention also relates to an apparatus for providing inflation fluid for inflating an inflatable vehicle occupant protection device. The apparatus includes an inflation fluid source actuatable to provide inflation fluid and a filter for filtering the inflation fluid. The filter is formed from at least one expanded metal sheet that is arranged in a desired configuration about a longitudinal axis. The expanded metal sheet when arranged in the desired configuration has a first wall thickness measured perpendicular to the longitudinal axis. The expanded metal sheet while in the desired configuration is crushed in a direction generally parallel to the longitudinal axis to form the filter. The filter has a second wall thickness that is at least twice the first wall thickness.

### BRIEF DESCRIPTION OF THE DRAWINGS

The foregoing and other features of the invention will become more apparent to one skilled in the art upon consideration of the following description of the invention and the accompanying drawings in which:

FIG. 1 is a schematic view of an apparatus for helping to protect an occupant of a vehicle, according to an embodiment of the present invention;

FIG. 2 is an enlarged view, partially in section, of a portion of the apparatus of FIG. 1;

FIGS. 3A and 3B are enlarged views of a material used to form a portion of the apparatus of FIG. 2;

FIG. 4A is a perspective view illustrating the production of a portion of the apparatus of FIGS. 1 and 2;

FIGS. 4B and 4C are sectional views illustrating the production of the portion of the apparatus of FIG. 4A;

FIG. 5 is a perspective view of the portion of the apparatus produced in FIGS. 4A-4C; and

FIGS. 6A and 6B are block diagrams illustrating a method for producing the portion of the apparatus of FIG. 5.

### DESCRIPTION OF EMBODIMENTS

Referring to FIG. 1, an apparatus 10 for helping to protect an occupant of a vehicle (not shown) includes an inflatable vehicle occupant protection device 16. In the illustrated embodiment of the present invention, the inflatable vehicle occupant protection device 16 comprises an air bag inflatable away from an instrument panel of the vehicle between the instrument panel and a vehicle occupant. For example, the inflatable vehicle occupant protection device 16 may be a driver side air bag inflatable from a stored condition in a vehicle steering wheel or a passenger side air bag inflatable from a stored condition in the instrument panel. As another example, the inflatable vehicle occupant protection device 16 could be an alternative inflatable device, such as an inflatable side curtain, an inflatable headliner, an inflatable seat belt, an inflatable knee bolster, or a knee bolster operated by an air bag.

The apparatus 10 includes an inflator 12 that is associated with the inflatable vehicle occupant protection device 16. The inflator 12 is actuatable to generate inflation fluid to inflate the inflatable vehicle occupant protection device 16.

The apparatus 10 also includes a sensor 14 for sensing a vehicle condition for which actuation of the inflator 12 may be desired. For example, the sensor 14 may sense vehicle deceleration. In this example, the sensor 14 measures the magnitude and duration of the vehicle deceleration. If the magnitude and duration of the deceleration meet predetermined threshold levels, the sensor 14 either transmits a signal or causes a signal to be transmitted to actuate the inflator 12. Upon actuation, the inflator 12 provides inflation fluid to inflate the inflatable vehicle occupant protection device 16. The protection device 16, when inflated, helps to protect an occupant of the vehicle.

In the illustrated embodiment, the inflator 12 is a pyrotechnic inflator that uses the combustion of gas-generating material to generate inflation fluid. The inflator 12 could, however, have a variety of alternative configurations. For example, the inflator 12 could be a stored gas inflator that contains a stored quantity of pressurized inflation fluid in the form of a gas. The inflator 12 alternatively could contain a combination of pressurized inflation fluid and ignitable material for heating the inflation fluid. As a further alternative, the inflator 12 could be of any suitable type or construction for supplying an inflation medium.

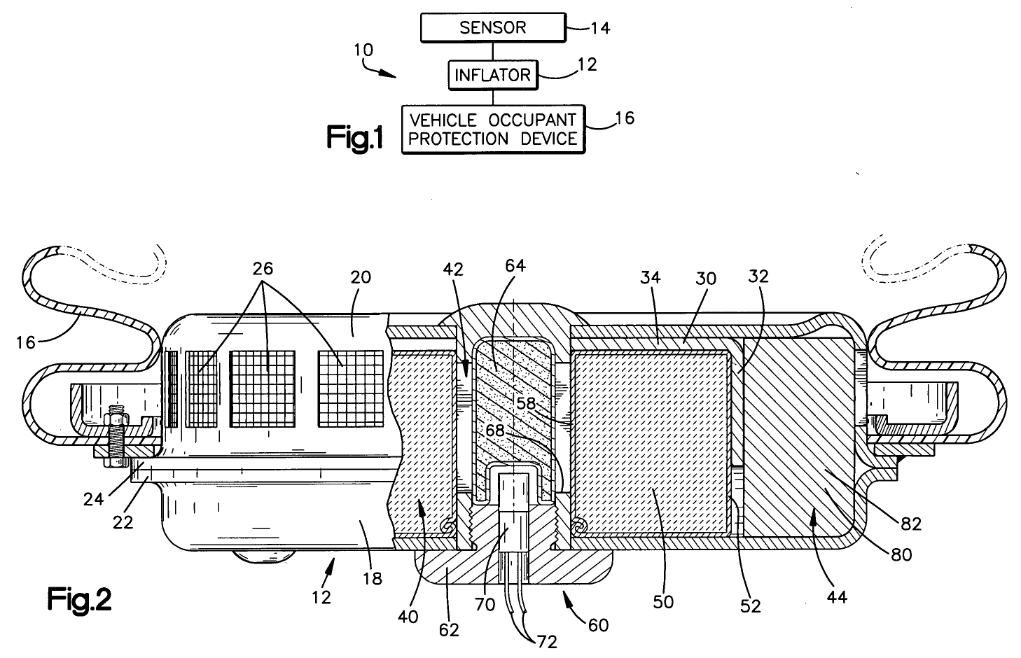

The specific configuration of the inflator 12 may vary. FIG. 2 illustrates an example of one possible configuration of the inflator 12. Referring to FIG. 2, the inflator 12 includes a base section 18 and a diffuser section 20. The two sections 18 and 20 are joined together at mounting flanges, 22 and 24, which are attached by means (not shown), such as welding, threaded fasteners, or rivets. The diffuser section 20 includes outlet openings 26 through which inflation fluid may be directed into the inflatable vehicle occupant protection device 16.

A combustion cup 30 is seated between the diffuser section 20 and the base section 18. The combustion cup 30 comprises an outer cylindrical wall 32 and an annular top wall 34. The combustion cup 30 helps define a combustion chamber 40, which is located within the combustion cup 30, and a filtration chamber 44, which is located outside the combustion cup 30. The combustion chamber 40 and filtration chamber 44 both have a generally cylindrical configuration defined by concentric cylindrical side walls of different diameters. The filtration chamber 44 extends annularly around the combustion chamber 40.

The combustion chamber 40 houses a gas generating material 50, which may be sealed in an inner container 52. The gas generating material 50 may be of any suitable type or configuration. The gas generating material 50 and inner container 52 have generally cylindrical, annular configurations and help define an ignition chamber 42.

The ignition chamber 42 receives an igniter 60. The igniter 60 includes a housing 62 that supports a body of ignitable material 64. The housing 62 also supports a squib 70 that contains a small charge of ignitable material (not shown). The squib 70 includes electric leads 72 that are operatively connected to the sensor 14 (see FIG. 1).

The apparatus 10 also includes an inflation fluid filter 80 through which inflation fluid passes prior to being discharged from the inflator 12 through the outlet openings 26. The filter 80 is disposed in the filtration chamber 44 and has a generally cylindrical configuration that mates with the cylindrical configuration of the filtration chamber. The filter 80 extends annularly around the combustion chamber 42 and the gas generating material 50 contained in the combustion chamber.

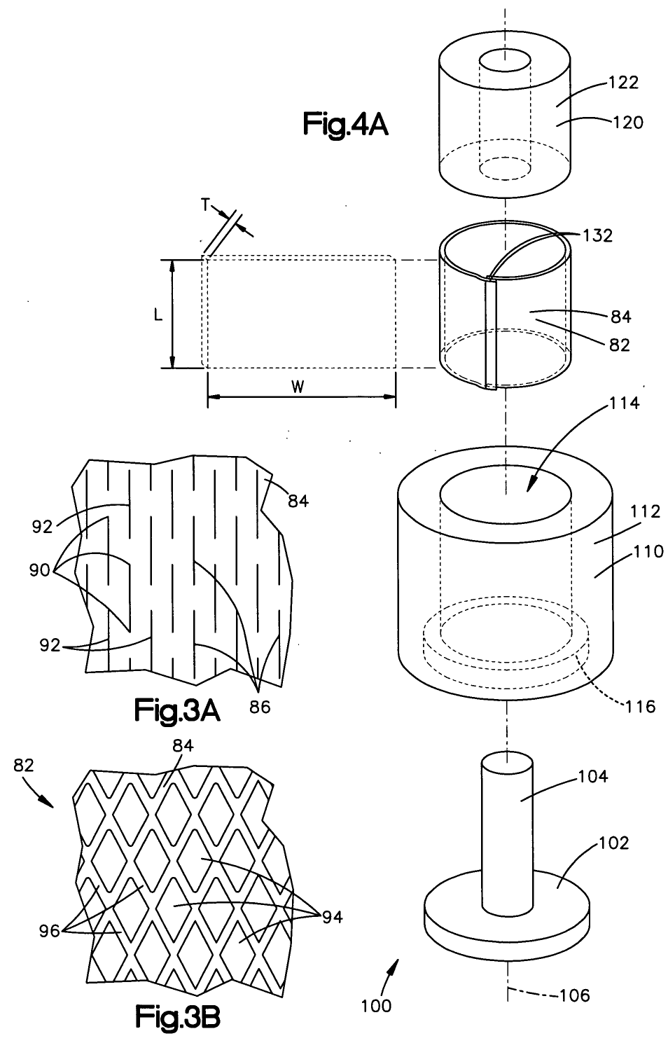

According to the present invention, the filter 80 is constructed of an expanded metal material in the form of an expanded metal sheet 82. Referring to FIGS. 3A and 3B, the expanded metal sheet 82 (FIG. 3B) is formed from a sheet 84 of metal material, such as carbon steel, stainless steel, or other suitable metal or metal alloy. The metal sheet 84 may have a thickness of about 0.10 millimeters or greater.

As shown in FIG. 3A, a plurality of longitudinal slits 86 are formed in the metal sheet 84. The slits 86 are arranged in rows and extend parallel to each other. The slits 86 are arranged so that slits in adjacent rows are offset from each other longitudinally. By way of example, as shown in FIG. 3A, the slits 86 may be arranged such that the ends 90 of any given slit are positioned proximate central portions 92 of slits in adjacent rows.

The expanded metal sheet 82 may be formed in a variety of known manners. For example, the expanded metal sheet 82 may be formed by tensioning or pulling on the metal sheet 84 in a direction transverse or perpendicular to the length of the slits 86. This causes the slits 86 to expand transverse to their length, thus forming openings 94 (FIG. 3B) in the metal sheet 84. The openings 94 are bounded by bars 96 of the metal material, which are defined by the slits 86 in the metal sheet 84. As another example, the expanded metal sheet 82 may be formed on a cutting machine (not shown) in which a serrated blade cuts the slits 86 in the metal sheet 84. The cutting machine may also displace or expand the metal bars 96 formed by the slits 86 as a part of the cutting operation. The cutting machine may thus, for example, cut a row of slits 86 in the metal sheet 84, displace the metal bars 96 formed by the slits in the row, and then feed or advance the metal sheet a predetermined distance to cut the next row of slits.

When being displaced to form the expanded metal sheet 82, the bars 96 may be displaced in a direction transverse to the thickness of the bars, i.e., transverse to the thickness of the metal sheet 82. To provide a more uniform thickness of the expanded metal sheet 82, the expanded metal sheet may also undergo a rolling operation in order to compensate for this transverse displacement. As shown in FIG. 3B, the openings 94 may have a generally diamond-shaped configuration in which each opening has a length, measured vertically as shown in FIG. 3B, and a width measured horizontally as shown in FIG. 3B. The length of the openings 94 is greater than the width of the openings. For example, the length of the openings 94 may be about twice the width of the openings, e.g., the width may be about 2 millimeters and the length may be about 4 millimeters.

The bars 96 have a generally rectangular cross-section formed by the flat upper and lower surfaces of the metal sheet 84 and the slits 86 cut perpendicularly through the sheet. The bars 96 have a thickness that is the same as the thickness of the metal sheet 84. The bars 96 have a width that is determined by the arrangement of the slits 86 on the metal sheet 84. As an example, the width of the bars 96 may be about equal to the thickness of the bars, thus giving the bars a generally square cross-section. The width of the bars 96 could, however, be different than the thickness of the bars, in which case the bars would have a generally rectangular cross-section.

The expanded metal sheet 82 is formed from a single piece of contiguous material. The expanded metal sheet 82 is free from separate pieces of material that are interconnected, such as woven materials, braided materials, plaited materials, or a non-woven web of discontinuous randomly oriented fibers. The expanded metal sheet 82, having a single piece construction, is strong, durable and resistant to movement of the bars 96 relative to each other.

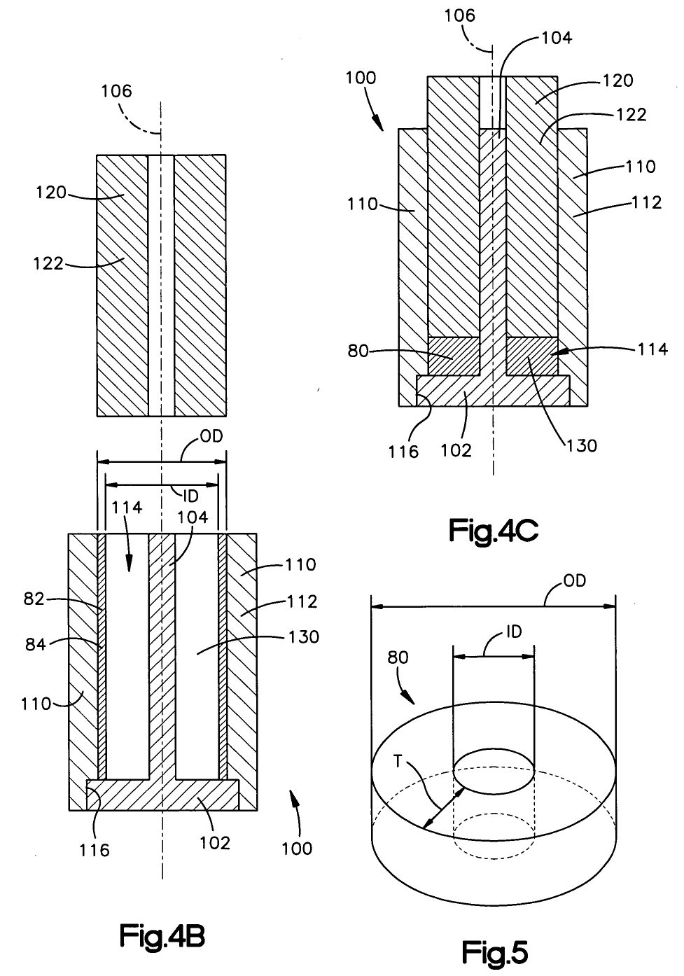

In the embodiment illustrated in FIGS. 4A-4C, a single expanded metal sheet 82 is arranged in a desired configuration and crushed to form the filter 80. Specifically, the single expanded metal sheet 82 is arranged in a cylindrical single layer configuration and crushed to form the filter 80. The expanded metal sheet 82 could alternatively be arranged in a desired multiple layer configuration and crushed to form the filter 80. As another alternative, multiple expanded metal sheets 82 could be arranged in a desired configuration and crushed to form the filter 80.

In the embodiment of FIGS. 4A-4C, a die 100 is used to form the filter 80 by crushing the expanded metal sheet 82 to the desired cylindrical configuration of the filter. The die 100 may be used in conjunction with a press (not shown) to crush the expanded metal sheet 82. The die 100 includes a cylindrical base 102 with an elongated cylindrical mandrel 104 that projects from the base along a central axis 106. The die 100 also includes a die housing 110 that has a cylindrical side wall 112 and a die plunger 120 that has a cylindrical side wall 122. The side wall 112 helps define a die cavity 114 in the die housing 110. The base 102 has a diameter configured for being received in an annular recess 116 formed at a terminal end of the die housing 110 such that the mandrel 104 projects into the die cavity 114.

The die plunger 120 has an outside diameter slightly smaller than the inside diameter of the side wall 112 of the die housing 110. The die plunger 120 also has an inside diameter slightly larger than the outside diameter of the mandrel 104. The die plunger 120 is thus insertable into the die cavity 114 while the base 102 is received in the recess 116 and mandrel 104 is positioned in the cavity. The die housing 110, base 102, and mandrel 104, when assembled together, thus define an open space 130 (FIG. 4B) in the die cavity 114 that has a configuration and dimensions about the same as those of the die plunger 120. The die plunger 120 is receivable in the open space 130 and can travel axially in the open space. The size or volume of the open space 130 thus varies according to the position of the die plunger 120 in the die housing 110.

Referring to FIG. 4A, the expanded metal sheet 82 is shown in a flat, un-rolled condition in dashed lines. The expanded metal sheet 82 has a length L, a width W, and a thickness T. The expanded metal sheet 82 is arranged in a generally cylindrical configuration as shown in solid lines in FIG. 4A. In the illustrated embodiment, the expanded metal sheet 82 is arranged in a single layer.

As shown in FIG. 4A, when the expanded metal sheet 82 is arranged in the cylindrical configuration, end portions 132 of the sheet may overlap each other slightly. In the single layer configuration, the amount of overlap may be kept to a minimum that is sufficient to close or complete the cylindrical configuration of the expanded metal sheet 82. For example, the overlap may be up to 20 millimeters or more. When the expanded metal sheet 82 is referred to herein as being arranged in a single layer configuration, it is meant to allow for no overlap or a slight overlap, leaving a substantial portion of the length, i.e., circumference, of the cylindrically configured sheet as a single layer.

Referring to FIG. 4B, the expanded metal sheet 82, when formed in the cylindrical configuration of FIG. 4A, has an outside diameter (OD) and an inside diameter (ID). The difference between these outside and inside diameters is equal to the wall thickness of the expanded metal sheet 82 when arranged in the desired configuration and prior to being crushed to form the filter 80. In the illustrated single layer configuration of FIG. 4B, this wall thickness is equal to the thickness of the expanded metal sheet 82.

The outside diameter of the expanded metal sheet 82, arranged in the cylindrical configuration of FIG. 4A, is about equal to the inside diameter of the die housing 110. The cylindrically configured expanded metal sheet 82 is thus insertable in the open space 130 formed by the housing, base 102, and mandrel 104. This is shown in FIG. 4B. When the cylindrically arranged expanded metal sheet 82 is positioned in the space 130, the end portions (not shown in FIG. 4B) are maintained in the overlapping relationship shown in FIG. 4A, thus maintaining the cylindrical configuration of the sheet.

With the expanded metal sheet 82 arranged in the cylindrical configuration in the space 130, the die plunger 120 is inserted into the die housing 110. This is shown in FIG. 4C. As shown in FIG. 4C, when the die plunger 120 is inserted into the die housing 110, the expanded metal sheet 82 is crushed or otherwise forced to conform to the space 130 defined by the die plunger, the mandrel 104, the side wall 112, and the base 102. As the die plunger 120 is urged into the die housing 110, the expanded metal sheet 82 is initially crushed in a vertical direction. As the die plunger 120 approaches the position of FIG. 4C, the expanded metal sheet 82 is displaced radially inward and the space 130 becomes filled with the expanded metal sheet. Further movement of the plunger 120 crushes the expanded metal sheet 82 in both axial and radial directions.

The die plunger 120 is urged a predetermined distance into the die housing 110 until the expanded metal sheet 82 is crushed to the desired filter 80 configuration. As the expanded metal sheet 82 is crushed, the bars 96 (see FIG. 3B) are displaced (e.g., bent, twisted, or otherwise distorted) and become entangled with each other. Referring to FIG. 5, the filter 80, when removed from the die 100, remains in the same generally cylindrical configuration as when crushed in the die.

Preferably, when the expanded metal sheet 82 is arranged in the cylindrical configuration and placed in the die housing 110, the respective lengths of the openings 94 in the sheet are aligned parallel to the axis 106. The expanded metal sheet 82 is thus crushed in a direction parallel to the lengths of the openings 94. This may be advantageous because the bars 96 defining the openings 94 may be more prone to bend, twist, or otherwise distort randomly and thereby may help provide a desired tortuous flow path. The expanded metal sheet 82 could, however, be arranged with the widths of the openings 94 extending parallel to the axis 106, in which case the sheet would be crushed in a direction parallel to the widths of the openings.

Referring to FIG. 5, the filter 80 has a wall thickness, indicated generally at T, that is measured as the difference between the outside diameter (O.D.) and the inside diameter (I.D.) of the filter. According to the present invention, the wall thickness T of the filter 80 is substantially greater than the thickness of the expanded metal sheet 82 when arranged in the die 100 prior to being crushed. The thickness of the filter 80 is at least twice the thickness of the expanded metal sheet 82 and may be up to twenty times the thickness of the sheet or more. It will thus be appreciated that, according to the present invention, forming the filter 80 with crushed expanded metal provides a wall thickness of the filter that might otherwise require several layers of material.

By way of example, in one configuration of the filter 80, the expanded metal sheet 82 may have a thickness of about 0.8 millimeters. The expanded metal sheet 82 is arranged in a single layer configuration in the die 100 with a 10-20 millimeter overlap. The expanded metal sheet 82, when crushed in the die to form the filter 80, has an O.D. of about 70 millimeters and an I.D. of about 63 millimeters. The filter 80 thus has a wall thickness of about 7 millimeters. Therefore, in this example, the filter 80 is formed by crushing a single layer expanded metal sheet 82 to have a wall thickness that is about 8.75 times the thickness of the sheet prior to being crushed.

In operation of the apparatus 10, upon sensing an event for which occupant protection is desired (e.g., a vehicle deceleration), the sensor 14 (FIG. 1) conveys a current to the squib 70 (FIG. 2) via the leads 72. The current actuates the squib 70 in a known manner. The squib 70, when actuated, ignites the ignitable material 64 of the igniter 60. The ignitable material 64, when ignited, ignites the gas generating material 50 in the combustion chamber 40. The gas generating material 50, when ignited, produces inflation fluid in the form of a gas that is directed through the filter 80 and exits the inflator 12 through the outlet openings 26 of the diffuser portion 20.

The bars 96 (FIG. 3B) of the filter 80, being entangled with each other, create tortuous paths through which the inflation fluid flows from the combustion chamber 40 to the outlet openings 26. In traveling this tortuous path, materials in the inflation fluid may be entrapped or otherwise collected by the bars 96 of the filter 80. For example, particulates in the inflation fluid may be collected by being trapped by the bars 96 of the filter 80. As another example, molten materials in the inflation fluid may be collected by being plated onto the bars 96 of the filter 80. The filter 80 may thus help filter particulates from the inflation fluid. The filter 80 may also act as a heat sink that helps cool the inflation fluid.

The filter 80 is also configured to permit a desired rate of inflation fluid flow through the filter and, thus, out of the inflator 12. For example, in the case of an inflator 12 for a driver side front impact air bag, the inflator may be required to provide inflation fluid flow at a rate of 1-2 kilograms per second. As another example, in the case of an inflator 12 for a passenger side front impact air bag, the inflator may be required to provide inflation fluid flow at a rate of 2-4 kilograms per second.

The degree of filtration performed by the filter 80, e.g., the particle size filtered from the inflation fluid, depends at least partially on the degree to which the expanded metal sheet 82 is crushed in the die 100. The degree to which the expanded metal sheet 82 is crushed can be quantified in terms of a percentage of solid density of the filter 80 after the filter is formed. “Percentage of solid density” is meant to describe the weight of the filter 80 constructed with the expanded metal sheet 82 divided by the weight of a solid constructed of the same material as the filter and occupying the same volume as the filter.

Because the volume occupied by the filter 80 includes the bars 96 of the expanded metal sheet 82 as well as empty space between the bars, the weight of the filter will be less than the weight of a solid occupying the same volume. The difference between these two weights depends on the degree to which the expanded metal sheet 82 is crushed in the die 100. For example, the filter 80 may be formed of a steel that has a density of about 8 grams per cubic centimeter (g/cm³). For purposes of simplicity, assume the filter 80 occupies a volume of 100 cm³ and weighs 400 grams. A solid having the same volume (i.e., 100 cm³) and constructed of the same steel would weigh 800 grams. Thus, in this example, the percentage of solid density of the filter 80 would be 50%, i.e., 50% of the solid density.

According to the present invention, the filter 80 may have a percentage of solid density of about 10-60%. More specifically, the filter 80 may have a percentage of solid density of about 20-50%. Knowing the desired configuration of the filter 80, a suitable die 100 or other device for forming the filter can be obtained. The volume occupied by the filter 80, known from the desired configuration, can be determined easily. Once the volume is determined, the dimensions of the expanded metal sheet 82 can be determined. One dimension of the expanded metal sheet 82 (e.g., the width W) is selected to provide the layer arrangement of the sheet with any desired overlap. The other dimension of the expanded metal sheet 82 (e.g., the length L) can be selected to provide the weight of material required to produce the desired percentage of solid density of the filter 80. The filter 80 when formed in the die 100 will thus have the desired configuration and percentage of solid density.

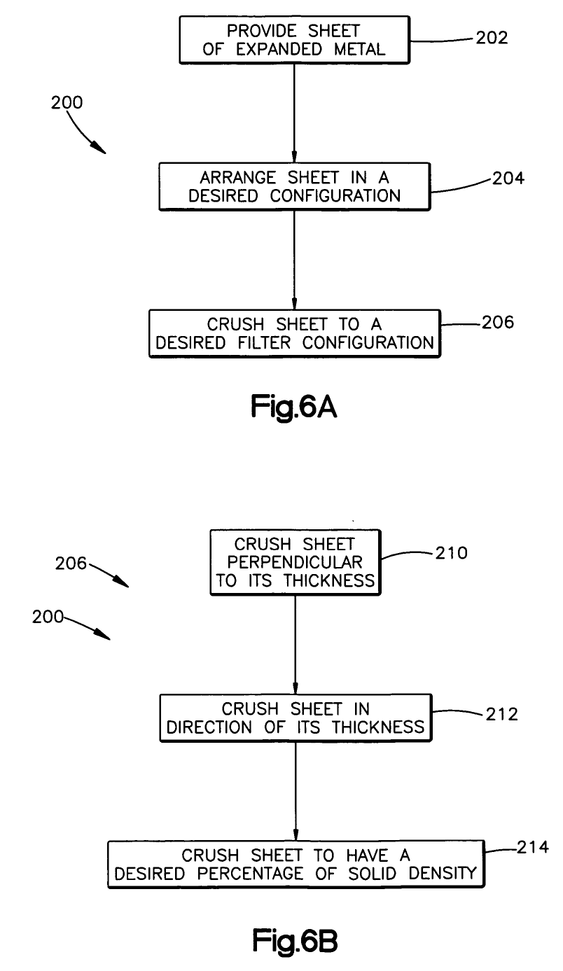

In view of the foregoing description, it will be appreciated that the present invention also relates to a method for forming a filter 80. The method 200 is illustrated in FIG. 6A. At step 202, one or more expanded metal sheets are provided. At step 204, the expanded metal sheet is arranged in a desired configuration (e.g., a single layer cylindrical configuration). At step 206, the expanded metal sheet is crushed to have a desired filter configuration, such as a cylindrical configuration with a desired wall thickness and a desired percentage of solid density.

Referring to FIG. 6B, step 206 of the method 200 may include the step of crushing the expanded metal sheet in a direction generally perpendicular to a thickness of the expanded metal sheet (e.g., parallel to the length or width of the sheet), as indicated at 210. The method 200 may also include the step of crushing the expanded metal sheet in the direction of its thickness, as indicated at 212. The method 200 may further include the step of crushing the expanded metal sheet to have a desired percentage of solid density, as indicated at 214.

From the above description of the invention, those skilled in the art will perceive improvements, changes and modifications. Such improvements, changes and modifications within the skill of the art are intended to be covered by the appended claims.

Having described the invention, the following is claimed:

1. An apparatus for providing inflation fluid for inflating an inflatable vehicle occupant protection device, said apparatus comprising:
an inflation fluid source actuatable to provide inflation fluid; and
a filter for filtering the inflation fluid provided by said inflation fluid source, said filter being formed from at least one expanded metal sheet that is crushed such that a wall thickness of said filter is at least twice a wall thickness of said expanded metal sheet prior to being crushed.

2. The apparatus recited in claim 1, wherein said at least one expanded metal sheet comprises a single expanded metal sheet, said single expanded metal sheet being arranged in a single layer configuration and crushed to form said filter.

3. The apparatus recited in claim 2, wherein said single expanded metal sheet has a thickness, said filter having a wall thickness that is at least twice as thick as said thickness of said single expanded metal sheet prior to being crushed.

4. The apparatus recited in claim 1, wherein said at least one expanded metal sheet prior to being crushed is arranged in a generally cylindrical configuration, said at least one expanded metal sheet when crushed forming said filter with a generally cylindrical configuration.

5. The apparatus recited in claim 4, wherein said at least one expanded metal sheet is arranged in said generally cylindrical configuration about an axis, said at least one expanded metal sheet being crushed parallel to said axis and being crushed radially with respect to said axis to form said filter.

6. The apparatus recited in claim 1, wherein said at least one expanded metal sheet is crushed in a direction generally perpendicular to a thickness of said at least one expanded metal sheet.

7. The apparatus recited in claim 6, wherein said at least one expanded metal sheet is crushed parallel to said thickness.

8. The apparatus recited in claim 1, wherein said filter has a percentage of solid density of about 10-60%.

9. The apparatus recited in claim 1, wherein said filter has a percentage of solid density of about 20-50%.

10. The apparatus recited in claim 1, wherein said at least one expanded metal sheet comprises a plurality of bars, each of said bars having a thickness of at least about 0.10 millimeters.

11. An apparatus for providing inflation fluid for inflating an inflatable vehicle occupant protection device, said apparatus comprising:
an inflation fluid source actuatable to provide inflation fluid; and
at least one expanded metal sheet crushed to define a filter having a wall thickness, said at least one expanded metal sheet when crushed defining a plurality of tortuous paths that extend through said wall thickness of said filter and along which the inflation fluid flows, materials in said inflation fluid being collected in said crushed expanded metal when said inflation fluid flows along said tortuous paths, said wall thickness of said filter being at least twice a thickness of said at least one expanded metal sheet.

12. An apparatus for providing inflation fluid for inflating an inflatable vehicle occupant protection device, said apparatus comprising:
an inflation fluid source actuatable to provide inflation fluid; and
a filter for filtering the inflation fluid provided by said inflation fluid source, said filter being formed from at least one expanded metal sheet that is arranged in a desired configuration about a longitudinal axis, said at least one expanded metal sheet when arranged in said desired configuration having a first wall thickness measured perpendicular to said longitudinal axis, said at least one expanded metal sheet while in said desired configuration being crushed in a direction generally parallel to said longitudinal axis to form said filter having a second wall thickness that is at least twice said first wall thickness.

13. A method for forming a filter for an inflator, the method comprising the steps of:
providing at least one expanded metal sheet;
arranging said at least one expanded metal sheet in a desired configuration; and
crushing said at least one expanded metal sheet to form a filter having a wall thickness that is at least twice a wall thickness of said at least one expanded metal sheet arranged in said desired configuration.

14. The method recited in claim 13, wherein said method further comprises the step of crushing said at least one expanded metal sheet in a direction generally perpendicular to a thickness of said at least one expanded metal sheet.

15. The method recited in claim 14, wherein said method further comprises the step of crushing said at least one expanded metal sheet in the direction of said thickness.

16. The method recited in claim 13, wherein said step of crushing said at least one expanded metal sheet to form a filter comprises the step of forming a filter that has a percentage of solid density of about 10-60%.

17. The method recited in claim 13, wherein said step of crushing said at least one expanded metal sheet to form a filter comprises the step of forming a filter that has a percentage of solid density of about 20-50%.

18. The method recited in claim 13, wherein said step of arranging said expanded metal sheet comprises the step of arranging said expanded metal sheet about a longitudinal axis such that said wall thickness of said expanded metal sheet is measured perpendicular to said longitudinal axis, said step of crushing said expanded metal sheet comprising the step of crushing said expanded metal sheet in a direction generally parallel to said longitudinal axis to form said filter.
